(19) United States
(12) Patent Application Publication
(10) Pub. No.: US 2026/0273321 A1
(43) Pub. Date: Sep. 17, 2026

(54) Fire Blanket with Accurate Tossing and Positioning

(71) Applicant: Ningbo SKL International Co., LTD, Ningbo City (CN)

(72) Inventor: Lingfeng Zhu, Ningbo City (CN)

(21) Appl. No.: 19/243,534

(22) Filed: Jun. 19, 2025

Related U.S. Application Data
(63) Continuation-in-part of application No. 30/008,020, filed on Jun. 12, 2025.

(30) Foreign Application Priority Data
Mar. 14, 2025 (CN) 2025220448282.5

(51) Int. Cl. A62C 8/06

(52) U.S. Cl. CPC A62C 8/06

(57) ABSTRACT

The utility model relates to a fire blanket with accurate tossing and positioning, which includes a fire blanket body. At least one counterweight block is arranged on the fire blanket body, the counterweight block is mounted on an axisymmetric line of the fire blanket body or symmetrically distributed on both sides of the axisymmetric line, and the at least one counterweight block is used as a grasping point for tossing the fire blanket body, so as to stabilize the tossing during firefighting; and the counterweight block located on both sides of the axisymmetric line is located at the edge of the fire blanket body.

### TECHNICAL FIELD

The present invention relates to the field of fire blankets, in particular to a fire blanket with accurate tossing and positioning mechanism.

### BACKGROUND OF DISCLOSURE

With continuous improvement of awareness of fire safety, demands for fire prevention equipment in various places continues to increase. Whether it is at home, office, shopping mall or industrial workshop, reliable fire prevention tools are needed to ensure the safety of life and property. Fire prevention tools include fire extinguishers, fire blankets, fire hydrants, etc. In the instructions, it is relatively easy to understand the use of the fire blanket, but it is very difficult to fully unfold and accurately toss the fire blanket in actual operation.

In today's society, with the continuous enhancement of people's awareness of fire safety, the demand for fire prevention equipment in various places has shown a rapid growth trend. From homes where people live daily, to office buildings where people work daily, then to shopping malls with dense crowds and dazzling commodities, as well as industrial workshops for production operations and other different scenes, reliable fire prevention tools are urgently needed to ensure the safety of life and property comprehensively.

Among numerous fire prevention tools, fire extinguisher has become an effective assistant to deal with the initial fire by virtue of an efficient firefighting ability thereof; as a fixed firefighting facility, the fire hydrant plays a key role in large-scale firefighting; while the fire blanket occupies an important position with unique firefighting and flame blocking functions thereof.

In the instructions of various fire prevention tools, an operation method of the fire blanket seems simple and easy to understand. In theory, users only need to unfold the fire blanket to cover a fire source and play the role of firefighting and blocking. However, once in an actual operation, the situation becomes complicated. It is not easy to fully unfold the fire blanket, and the material characteristics of the fire blanket per se, such as hard texture and difficulty in quick opening after folding, possibly become obstacles. Moreover, in an emergency and flustered fire scene environment, it is even more difficult to accurately toss the fire blanket. If there is a slight deviation, the fire source is possibly not covered completely, which will greatly reduce the firefighting effect and make it difficult to give full play to its due fire prevention and flame retardant effects.

### BRIEF SUMMARY OF EMBODIMENTS

Aiming at the shortcomings in the prior art, the present invention provides a fire blanket with accurate tossing and positioning. A counterweight block is arranged on a fire blanket body of the fire blanket, and the counterweight block is used as a grasping point to ensure accurate tossing of the fire blanket.

In order to achieve the above object, the present invention adopts the technical solution as follows:

A fire blanket with accurate tossing and positioning includes a fire blanket body, wherein at least one counterweight block is arranged on the fire blanket body, the counterweight block is mounted on an axisymmetric line of the fire blanket body or symmetrically distributed on both sides of the axisymmetric line, and the at least one counterweight block is used as the grasping point for tossing the fire blanket body, so as to stabilize the tossing during firefighting; and
the counterweight block located on both sides of the axisymmetric line is located at the edge of the fire blanket body.

Preferably, two counterweight blocks are arranged, and the two counterweight blocks fly out with the fire blanket body and are distributed on both sides of a fire source.

Preferably, a plurality of counterweight blocks are arranged, and the plurality of counterweight blocks fly out with the fire blanket body and are distributed around the fire source.

Preferably, a chamber where the counterweight block is capable of being placed is arranged on the fire blanket body, and an opening of the chamber is sealable.

Preferably, the fire blanket body is provided with a connector connectable to the counterweight block, and the counterweight block is connected and fixed with the connector.

Preferably, the counterweight block is fixed with the connector by means of magnetic attraction or adhesion.

Preferably, the counterweight block is fixed with the connector by means of snap-fitting or hooking.

Preferably, a handle structure is constructed on the counterweight block for tossing.

Compared with the prior art, the present invention has the following beneficial effects:

The utility model provides a fire blanket with accurate tossing and positioning. By arranging the counterweight block on the fire blanket body and taking the counterweight block as the grasping point, accurate tossing of the fire blanket is ensured.

According to the utility model, greater initial speed and strength can be obtained by arranging different numbers and distribution modes of counterweight blocks, such as arranging one counterweight block at one corner or one side; two counterweight blocks arranged side by side can be tossed by both hands of one person or two persons together, and the diagonal or opposite distribution can prevent the fire blanket from flying over the fire source or being blown up; the even distribution of four or more counterweight blocks can ensure that the fire blanket is clung to the fire source, the fire blanket can be tossed stably in a large area when being tossed by many persons, and the fire blanket can be prevented from entanglement when being tossed by one person, to ensure the maximum area coverage of a target region. Stable tossing and accurate positioning can be realized.

### DESCRIPTION OF DRAWINGS

In order to explain the technical solution in the embodiments of the present invention more clearly, the drawings needed in the embodiments will be briefly introduced below. Obviously, the drawings in the following illustrations are merely some embodiments of the present invention, and other drawings may be obtained according to these drawings for those of ordinary skill in the art, without paying creative labor.

FIG. 1 is an overall schematic structural diagram with one counterweight block arranged according to the present invention;

FIG. 2 is an overall schematic structural diagram with two counterweight blocks arranged according to the present invention;

FIG. 3 is an overall schematic structural diagram with a plurality of counterweight blocks arranged according to the present invention; and

FIG. 4 is a three-dimensional schematic structural diagram with one counterweight block arranged according to the present invention.

Illustrations of reference signs: 1, fire blanket body; 2, counterweight block; 3, handle structure.

### DETAILED DESCRIPTION OF EMBODIMENTS

The present invention will be described in further detail below in combination with the drawings.

The following illustrations are used for disclosing the present invention, so that those skilled in the art can implement the present invention. The preferred embodiments in the following illustrations are merely examples, and other obvious variations may occur to those skilled in the art. The basic principles of the present invention defined in the following illustrations may be used for other embodiments, variation solutions, improvement solutions, equivalent solutions and other technical solutions without departing from the spirit and scope of the present invention.

It should be understood by those skilled in the art that in the disclosure of the present invention, the orientations or positions indicated by the terms such as “longitudinal”, “transverse”, “upper”, “lower”, “left”, “right”, “front”, “rear”, “vertical”, “horizontal”, “top”, “bottom”, “inner” and “outer” are the orientation or position relationships shown based on the drawings, only for the convenience of describing the simplified illustrations of the present invention, rather than indicating or implying that the referred device or element must have a specific orientation and be constructed and operated in a specific orientation. Therefore, the above terms cannot be understood as limiting the present invention.

It can be understood that the term “one” should be understood as “at least one” or “one or more”, that is, in one embodiment, the number of one element may be one, while in other embodiments, the number of the elements may be more, and the term “one” cannot be understood as a limitation on the number.

### EMBODIMENTS

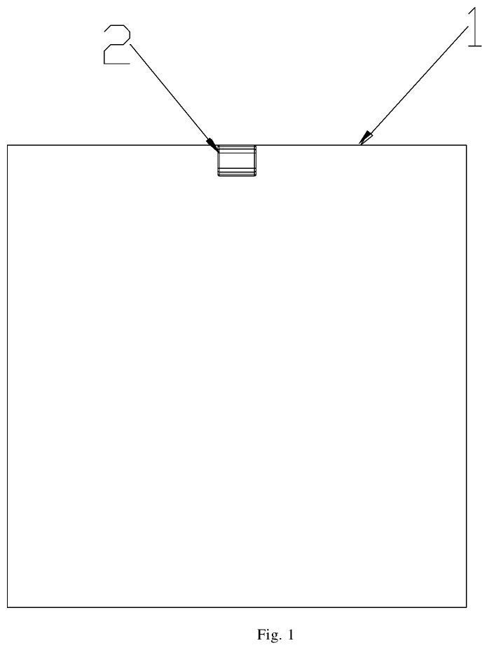

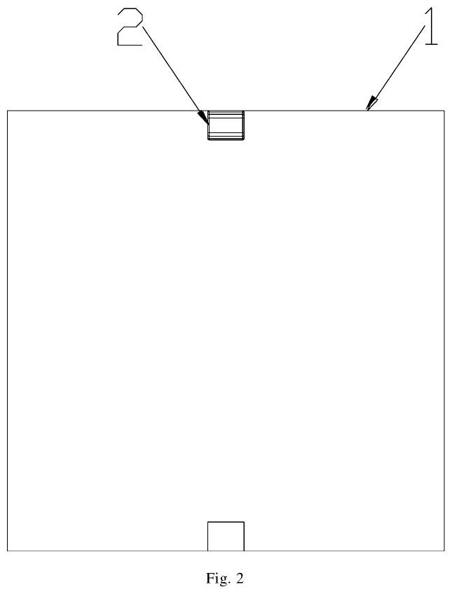

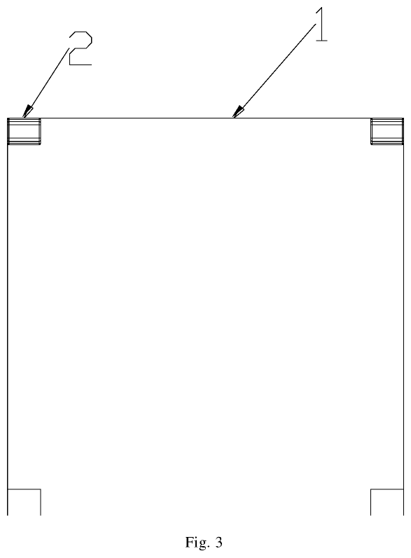

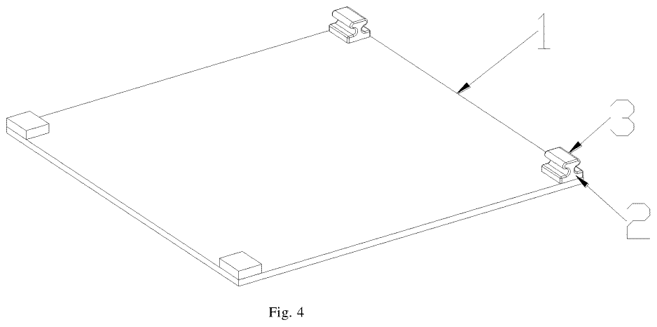

Please refer to FIGS. 1-4. A fire blanket with accurate tossing and positioning includes a fire blanket body 1, at least one counterweight block 2 is arranged on the fire blanket body 1, the counterweight block 2 is mounted on an axisymmetric line of the fire blanket body 1 or symmetrically distributed on both sides of the axisymmetric line, and the at least one counterweight block 2 is used as a grasping point for tossing the fire blanket body 1, so as to stabilize the tossing during firefighting.

The counterweight block 2 located on both sides of the axisymmetric line is located at the edge of the fire blanket body 1.

In a specific implementation process, the number of the counterweight blocks 2 arranged on the fire blanket body 1 varies from one to more.

When only one counterweight block 2 is arranged, the counterweight block 2 serves as the grasping point for tossing the fire blanket body 1, the counterweight block 2 is arranged on the axisymmetric line of the fire blanket body 1, and the fire blanket body 1 is tossed out by holding the counterweight block 2, so that greater initial speed and strength can be obtained when the fire blanket body is tossed out, to stabilize the tossing during firefighting. The flying direction and spreading effect of the fire blanket are better controlled by operating and controlling the counterweight block 2 in a tossing process. In turn, it can also ensure that the fire blanket can be tossed and positioned accurately when used in a long distance.

When two counterweight blocks 2 are arranged, the two counterweight blocks 2 may be arranged on both sides of the axisymmetric line side by side, then the two counterweight blocks 2 both serve the grasping points for tossing the fire blanket body 1, and the fire blanket can be fully unfolded when being tossed forward at an obtuse angle or an acute angle in the horizontal direction by both hands of one person; when the fire blanket is tossed by two persons together, a tossing distance can be increased.

When two counterweight blocks 2 are arranged, the two counterweight blocks 2 may also be both arranged on the axisymmetric line, the two counterweight blocks 2 are distributed one behind the other during tossing, the front counterweight block 2 serves as the grasping point for tossing the fire blanket body 1, and the rear counterweight block 2 flies out with the fire blanket body 1. The two counterweight blocks 2 are controlled to fall on both sides of a fire source, so as to ensure that the fire blanket body 1 can cover the fire source, the fire blanket body 1 is prevented from flying over the fire source due to inertia, and the fire blanket body 1 is also prevented from being blown up by a burning airflow.

When four counterweight blocks 2 are arranged, they may be evenly distributed on the fire blanket body 1 and selectively held at this time, and the above tossing ways are adopted. The four counterweight blocks 2 are selected and preferably fixed at four corners or four sides of the rectangular fire blanket body 1. With the increase of the number of the counterweight blocks 2, the four counterweight blocks 2 may be distributed around the fire source by controlling a tossing strength, which can ensure that the fire blanket body 1 is clung to the fire source and better isolated from air.

It should be noted that when more counterweight blocks 2 are arranged, the counterweight blocks 2 may be evenly distributed according to the shape of the fire blanket body 1. When many persons cooperate to toss the fire blanket, the persons at different positions may hold the corresponding counterweight blocks respectively, thus realizing stable and large-area tossing of the fire blanket. However, when tossing by one single person, the person may only hold one counterweight block 2 and imitate the action of casting a net to toss the fire blanket out. With the weights of the counterweight blocks 2 per se, not only can enough initial power be provided for the fire blanket to fly a longer distance during tossing, but also the fire blanket is driven to be unfolded in the flying process, so as to avoid the situation that the fire blanket is entangled in the air and cannot be fully unfolded, which ensures that the fire blanket covers a target region with the maximum area, and gives full play to its fire prevention and heat insulation functions.

In one fire blanket with accurate tossing and positioning according to the present application, the fire blanket body 1 and the counterweight block 2 have multiple connection ways, including the following:

In some embodiments, the fire blanket body 1 may be connected and fixed with the counterweight block 2 by means of sewing or fastening, to keep a non-detachable state. Therefore, it is not necessary to spend time assembling the counterweight block and the fire blanket body, and the fire blanket can be directly tossed after being picked up, thus saving valuable time for firefighting and improving an emergency response speed.

In some other embodiments, the fire blanket body 1 and the counterweight block 2 may be kept in detachable connection. Therefore, the cleaning or maintenance and folding preservation of the fire blanket body 1 can be facilitated, and it is more convenient for replacement for the cases that the fire blanket body 1 is damaged or the counterweight block 2 is worn or aged in a use process. After the counterweight block 2 is removed, the fire blanket body 1 is used as a simple heat insulation mat, protective cloth, etc., without being limited by the counterweight block, thus increasing the functional diversity of the fire blanket.

A chamber with an opening may be sewn on the fire blanket body 1 through fire cloth, the counterweight block 2 is placed in the chamber, and the opening may be deformed by interference fit between the counterweight block 2 and the chamber, to ensure that the counterweight block 2 does not easily fall off. Buttons or zippers may also be sewn at the opening for sealing.

One connector may be sewn on the fire blanket body 1 for connecting the counterweight block 2.

The preferred connector is a fire-resistant velcro, and a son sticker and a mother sticker of the fire-resistant velcro are respectively arranged on the fire blanket body 1 and the counterweight block 2. The counterweight block 2 is fixed on the fire blanket body 1 through bonding of the son sticker and the mother sticker. Since the fire-resistant velcro is made of fire-resistant materials, it can still maintain good adhesiveness and firmness in a high temperature environment, and will not fail due to heating, thus ensuring a use effect of the fire blanket in fire scenes.

The preferred connector is a refractory magnet, and opposite magnetic poles of the refractory magnet are respectively mounted on the fire blanket body 1 and the counterweight block 2. The counterweight block 2 is fixed on the fire blanket body 1 by using the characteristic that opposite magnets attract each other. Since the refractory magnet is made of a special refractory material, it can still maintain stable magnetism and structural strength in a high temperature environment, and will not lose magnetism or be damaged due to heating, thus greatly ensuring the use effect of the fire blanket in the fire scenes.

In one fire blanket with accurate tossing and positioning according to the present application, the counterweight block 2 may be designed in various styles, including the following:

When the counterweight block 2 is arranged in a block or ball shape, it is mainly distributed at the corner of the fire blanket body 1;

When the counterweight block 2 is arranged in a strip shape, it is mainly distributed on the edge of the fire blanket body 1.

In some embodiments, the counterweight block 2 may also be integrated with hook, and a plurality of hook rings are arranged on the fire blanket body for connecting with the hook.

In addition, one or two counterweight blocks 2 for tossing are provided with a handle structure 3 to facilitate the tossing and grasping.

It should be understood by those skilled in the art that the embodiments of the present invention described above and shown in the drawings are only examples without limiting the present invention. The object of the present invention has been completely and effectively achieved. The functions and structural principle of the present invention have been shown and explained in the embodiments, and the embodiments of the present invention can have any transformation or modification without departing from the principle.

1. A fire blanket for accurate tossing and positioning, comprising a fire blanket body (1), wherein at least one counterweight block (2) is arranged on the fire blanket body (1), the counterweight block (2) is mounted on an axisymmetric line of the fire blanket body (1) or symmetrically distributed on both sides of the axisymmetric line, and the at least one counterweight block (2) is used as a grasping point for tossing the fire blanket body (1), so as to stabilize the tossing during firefighting; and
the counterweight block (2) located on both sides of the axisymmetric line is located at the edge of the fire blanket body (1).

2. The fire blanket for accurate tossing and positioning according to claim 1, characterized in that two counterweight blocks (2) are arranged, and the two counterweight blocks (2) fly out with the fire blanket body (1) and are distributed on both sides of a fire source.

3. The fire blanket for accurate tossing and positioning according to claim 1, characterized in that a plurality of counterweight blocks (2) are arranged, and the plurality of counterweight blocks (2) fly out with the fire blanket body (1) and are distributed around the fire source.

4. The fire blanket for accurate tossing and positioning according to claim 1, characterized in that a chamber where the counterweight block (2) is capable of being placed is arranged on the fire blanket body (1), and an opening of the chamber is sealable.

5. The fire blanket for accurate tossing and positioning according to claim 1, characterized in that the fire blanket body (1) is provided with a connector connectable to the counterweight block (2), and the counterweight block (2) is connected and fixed with the connector.

6. The fire blanket for accurate tossing and positioning according to claim 5, characterized in that the counterweight block (2) is fixed with the connector by means of magnetic attraction or adhesion.

7. The fire blanket for accurate tossing and positioning according to claim 5, characterized in that the counterweight block (2) is fixed with the connector by means of snap-fitting or hooking.

8. The fire blanket for accurate tossing and positioning according to claim 1, characterized in that a handle structure (3) is constructed on the counterweight block (2) for tossing.
